(19) United States
(12) Patent Application Publication
(10) Pub. No.: US 2021/0153488 A1
(43) Pub. Date: May 27, 2021

(54) TACKLE HOLDER AND STORAGE

(71) Applicant: Peninsula Tackle LLC, Traverse City, MI (US)

(72) Inventors: Erik White, Ann Arbor, MI (US); Joshua Kelly, Hendersonville, NC (US); Michael Stallman, Traverse City, MI (US)

(73) Assignee: Peninsula Tackle LLC, Traverse City, MI (US)

(21) Appl. No.: 17/100,058

(22) Filed: Nov. 20, 2020

Related U.S. Application Data
(60) Provisional application No. 62/939,159, filed on Nov. 22, 2019.

(51) Int. Cl. A01K 97/06

(52) U.S. Cl. CPC A01K 97/06

(57) ABSTRACT

A tackle box assembly can include an outer casing including a first half and a second half defining an interior. The first half and the second half can be adjoined at a spine at hinged connections. An insert can be attached to the spine, such that the insert is housed within the interior when the outer casing is provided in a closed position. The outer casing provides for carrying and holding the insert when in an opening position, permitting the user to interact with one or more lures provided on the insert within the field.

### CROSS-REFERENCE TO RELATED APPLICATION(S)

This application claims priority to and the benefit of U.S. Provisional Patent Application No. 62/939,159, filed on Nov. 22, 2019, the entirety of which is incorporated herein by reference.

### TECHNICAL FIELD

The disclosure generally relates to a tackle box, anglers artificial fly, pre-rigged leader holder, or fishing lure storage equipment. Furthermore, the disclosure generally relates to the preparation of artificial fishing lures, such as fly-fishing baits, and the storage and protection thereof for use in the field.

### BACKGROUND

During fly fishing, anglers or fisherman are often wading into the water they are fishing, or move along the shore during fishing. While wading or moving along the shore, it is advantageous to carry tackle and lures for easy access and rigging. However, there is a need for a system that can safely and securely store pre-made fishing lures, as well as provide easy access to the lures during fishing in the field. More specifically, fly fisherman often store spare fly lures on their clothing, vests, or hats. However, storing lures with this method are susceptible to becoming dislodged, damaged, or tangled, often due to the nearby environment during fishing. Therefore, there is a need to carry the lures in a protected manner, which provides for easy access and carrying by the fisherman.

### BRIEF DESCRIPTION

In one aspect, the disclosure relates to a tacklebox for storing and preparing lures, the tacklebox comprising: a casing defining an interior, the casing including a first casing half and a second casing half joined to the first casing half at a spine, the casing moveable between a closed position and an opened position; an insert removably attached to the casing at the spine and enclosed within the interior when the casing is in the closed position; and at least one finger provided on the spine configured to removably secure the insert to the casing at the spine.

In another aspect, the disclosure relates to a tacklebox assembly comprising: a casing including a first half connected to a second half by a spine, and the casing movable between an opened position and a closed position at least one insert removably attached to the casing at the spine and configured to carry fishing lures.

In another aspect, the disclosure relates to a method of storing lures in a tackle box assembly, the method comprising; attaching at least one lure to an insert carried within a casing; removably securing the insert to a spine of the casing by positioning at least one finger on the spine into at least one complementary slot on the insert, and closing the casing by attaching a first half to a second half, encasing the insert.

### BRIEF DESCRIPTION OF THE DRAWINGS

In the drawings:

FIG. 1 is a view of a tackle box in a closed position having a latch to secure the tackle box in the closed position.

FIG. 2 is the tackle box of FIG. 1 in a partially-opened position, showing a removable insert for carrying fishing lures and tackle.

FIG. 3 is a view of the tackle box in a fully-opened position, with the latch of FIG. 1 securing the tackle box in the fully-opened position.

FIG. 4 is another view of the tackle box of FIG. 3 in the fully-opened position showing the removable insert exploded from the remainder of the tackle box.

FIG. 5 is an alternative view of the tackle box of FIG. 1, showing an insert holder connected to the removable insert and exploded from the remainder of the tackle box.

FIG. 6 is a view of just the insert holder of FIG. 5 and the removable insert exploded from the insert holder.

FIG. 7 is a view of an alternative tackle box assembly including inserts connected to an interior of an outer casing.

FIG. 8 is a view of yet another alternative tackle box assembly including inserts that are removably connectable to the casing with pegs.

### DETAILED DESCRIPTION OF THE INVENTION

Aspects of the disclosure described herein are broadly directed to an apparatus and method for carrying and storing fishing lures. More specifically, the apparatus and method can be related to preparing or storing fly fishing lures, which can be carried into the field for use or rigging in the field, without returning to a dedicated tackle box or preparation site outside of the immediate fishing area. Furthermore, the apparatus and method can be used to store or prepare fishing lures prior to fishing, such as safely and securely storing fly fishing lures, already attached to leaders and ready for use. Further yet, the apparatus and method can include a removable portion, which can be used to carry the fishing lures and can be attached to or conveniently carried by the user into the field without the bulk of an outer casing.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are used only for identification purposes to aid the reader's understanding of the present disclosure, and should not be construed as limiting on an embodiment, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order, and relative sizes reflected in the drawings attached hereto can vary. Additionally, as used herein, a ‘set’ or ‘set of elements’ can refer to any number of the related element, including only one.

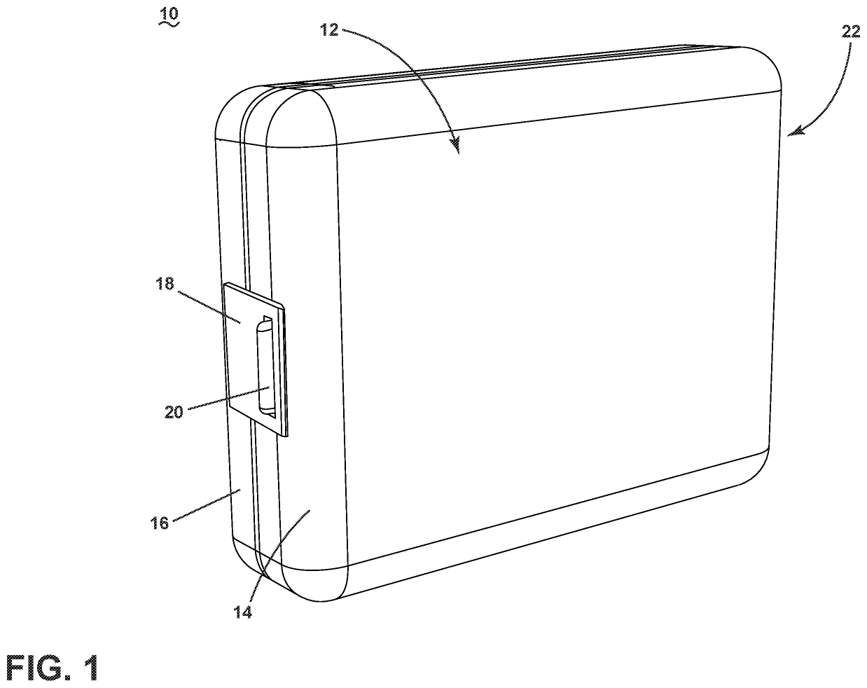

Referring now to FIG. 1, a tackle box assembly 10 includes an outer casing 12. The outer casing 12 can be made of any suitable material for protecting interior items stored within the outer casing 12, such as plastics or composites in non-limiting examples. Additionally, the outer casing 12 can be clear or at least partially transparent or translucent, permitting a user to view the interior contents of the tackle box assembly 10 without opening the outer casing 12. The outer casing 12 can have a substantially box-like shape, such as a hyperrectangle, right rectangular prism, cuboid, or rectangular parallelepiped in non-limiting examples, having rounded corners, while any suitable shape is contemplated. The outer casing 12 can be split into halves, defining a first half 14 and a second half 16, forming a clamshell-type enclosure for the outer casing 12.

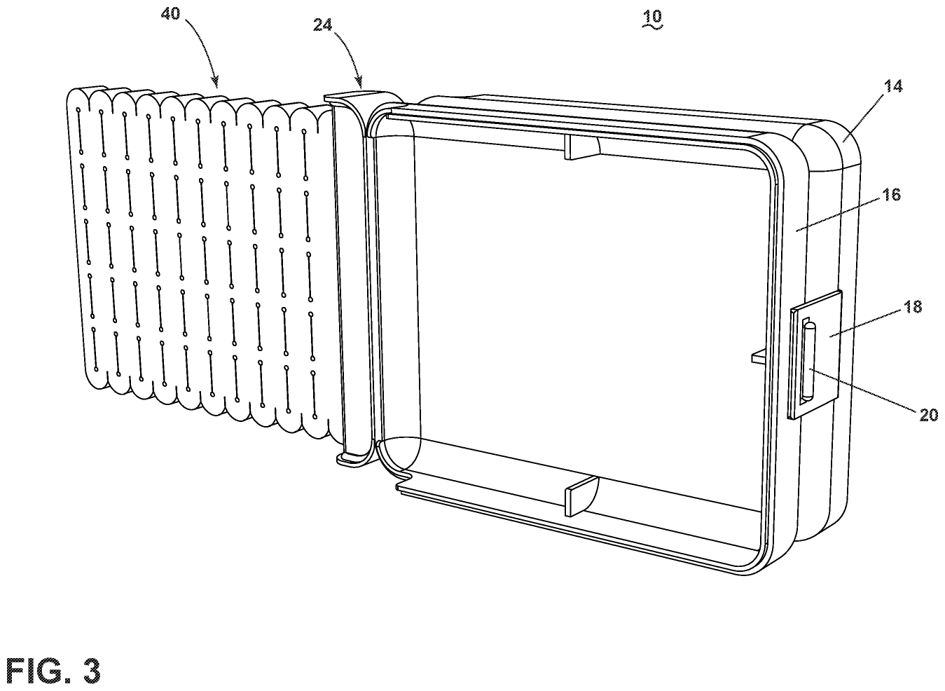

A latch 18 is provided on one end of the outer casing 12, with a tab 20 for securing the latch 18 to secure the outer casing 12 in the closed position. In one example, the tab 20 can be provided on the first half 14 and the latch 18 can be provided on the second half 16 of the outer casing 12, while the opposite arrangement is contemplated. A hinge assembly 22 can be provided on the outer casing 12, opposite the latch 18, permitting 180-degree pivoting movement for both the first half 14 and the second half 16 about the hinge assembly 22, after release of the latch 18. While shown and described herein as a latch, any suitable fastener is contemplated, such as magnets in one non-limiting example, to keep the tackle box assembly 10 closed in the closed position, or opened in the fully opened position, best seen in FIG. 3.

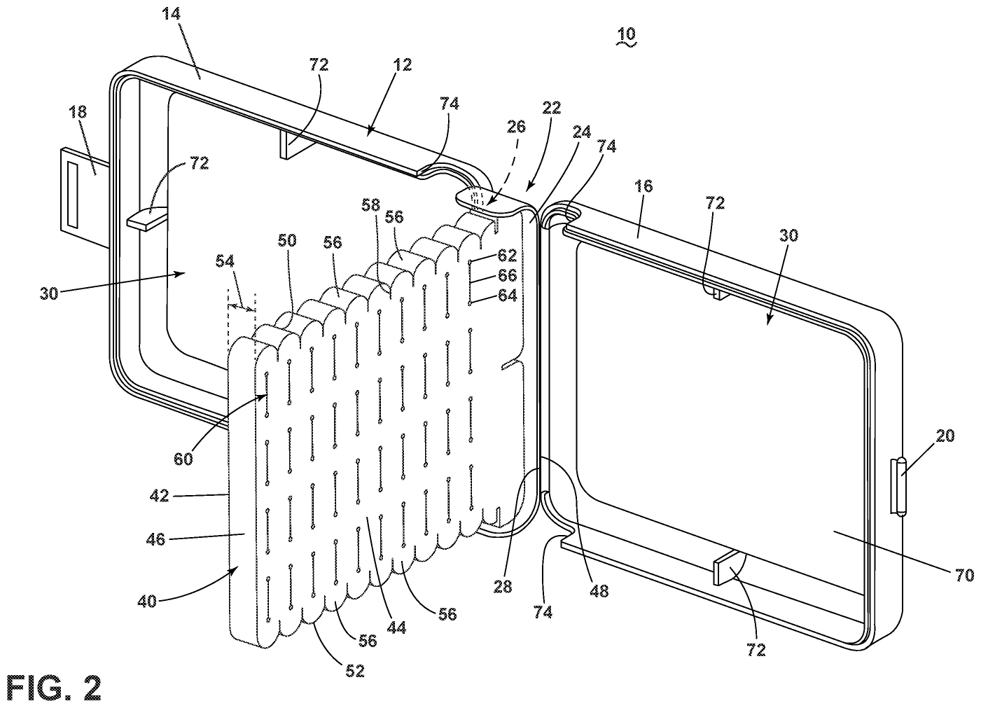

Turning to FIG. 2, the outer casing 12 has been opened at the latch 18 to a partially-opened position, with the first and second halves 14, 16 pivoting about the hinge assembly 22. As is appreciable in FIG. 2, the latch 18 extends from the first half 14 and the tab 20 extends from the second half 16 when separated. The first half 14 and the second half 16 are shaped as halves of a clamshell, such that an interior 30 is defined by the first half 14 and the second half 16 when in the closed position.

The hinge assembly 22 can further include a spine 24, with a first hinge 26 and a second hinge 28. The first hinge 26 can pivotably couple the spine 24 to the first half 14, while the second hinge 28 can couple the spine 24 to the second half 16 of the outer casing 12. The first hinge 26 is substantially hidden behind the spine 24 in the view shown, but can be identical to that of the second hinge 28 as shown, only providing a pivoting connection between the spine 24 and the first half 14. The first hinge 26 and the second hinge 28 can pivot 180-degrees, relative to the spine 24, to permit ease of access to the interior 30.

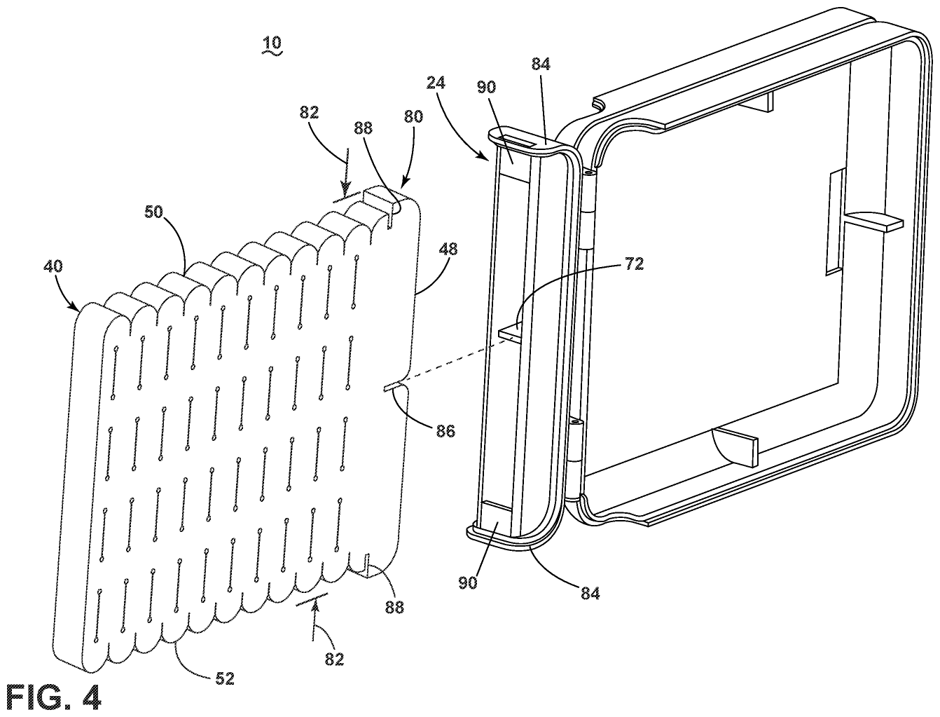

A removable insert 40 is attached to the spine 24. The removable insert 40 is mounted to the spine 24 such that the insert 40 is positioned within the interior 30 of the tackle box assembly 10 when the first half 14 and the second half 16 are in the closed position. The removable insert 40 includes a front face 42 and a rear face 44, as well as an exterior edge 46, an interior edge 48 at the spine 24, and a top edge 50 and a bottom edge 52. The exterior edge 46 can be flat and linear, extending between the front face 42 and the rear face 44, defining a thickness 54 for the insert 40. The interior edge 48 can also be at least partially flat and linear, adapted to secure at the spine 24, which will be discussed in further detail in the discussion of FIGS. 4-6. The top edge 50 and the bottom edge 52 can include a set of semi-circular bumps 56, formed as rounded protuberances having a semi-cylindrical shape extending between the front face 42 and the rear face 44. The bumps 56 can define a series of grooves 58 along the top edge 50 and the bottom edge 52 provided between adjacent bumps 56. In one example, the grooves 58 can be sized and spaced such that a fishing line or leader line can be removably secured within the grooves 58 for carrying or holding a lure for storage, repair, or creation of the lure, as well as attaching line or leaders to the lure.

The removable insert 40 can be made from a compressible or moldable foam, such that compression of the insert 40 is possible, with the foam returning to the original position and form of the insert 40 after compression. In one non-limiting example, a memory foam, such as an elastomeric or polymeric material is contemplated, while more inexpensive materials, such as a polystyrene foam are contemplated. In another example, the insert 40 can include an internal reinforcement, such as a wire or plastic frame. Such a reinforcement can help stiffen the foam, which can help maintain the shape of the foam during the lifetime use of the insert 40.

A set of openings 60 are provided in the insert 40, extending between the front face 42 and the rear face 44, spaced from the edges 46, 48, 50, 52, while it is contemplated that the openings 60 may be integrated at one or more of the edges 46, 48, 50, 52. The openings 60 each include an upper hole 62 and a lower hole 64, with the holes 62, 64 interconnected by a slit 66 also extending between the front face 42 and the rear face 44. Preferably, the set of openings 60 are sized, spaced, arranged, or otherwise adapted to store a fishing fly or multiple flies that already have an attached leader or tippet. For example, as shown, the set of openings 60 are arranged in four rows and ten columns, with the slits 66 in alignment in a direction between the tip edge 50 and the bottom edge 52. Additionally, the arrangement of the bumps 56 and the openings 60 can provide for securing the fly or lure, permitting a user to manipulate the fly, such as repairing or changing the lure at the tackle box assembly 10, as can be desirable when in the field. As shown, the grooves 58 are offset from the columns of the openings 60, while alternate arrangements are contemplated.

Additionally, the outer casing 12 can include an interior surface 70, with one or more ribs 72 extending into the interior 30 from the interior surface 70 of the outer casing 12. The ribs 72 can be arranged to secure against portions of the insert 40, such as arranged to position between adjacent bumps 56 of the top and bottom edges 50, 52, or the ribs 72 can abut the insert 40 at one or both the of the exterior and interior edges 46, 48. The ribs 72 provide for positioning and securing the insert 40 within the interior 30, as well as against the first or second half 14, 16 of the outer casing 12, when the outer casing 12 or one half 14, 16 is in the closed position.

Further yet, the outer casing 12, at both the first and second halves 14, 16, can include a casing end 74, where the casing 12 includes a lesser width adapted to fit and abut the spine 24 when moving the tackle box assembly 10 to the closed position. Additionally, it is contemplated that a grommet or other seal can be provided around the first and second halves 14, 16 of the outer casing 12, as well as at the casing ends 74, to seal the interior 30 when the tackle box assembly 10 is in the closed position.

It should also be appreciated that embodiments are contemplated where the insert 40 is affixed to the spine 24. Such fixing can be with an adhesive, for example, while any suitable fastener or system is contemplated. In such an embodiment, the insert 40 would not be removable from the spine 24 or the rest of the outer casing 12.

Referring now to FIG. 3, the tackle box assembly 10 is opened into the fully-opened position. In the fully-opened position, the first half and the second half 14, 16 can meet opposite of that of the closed-position as shown in FIG. 1. The tackle box assembly 10 can be secured in the fully-opened position by utilizing the latch 18 and tab 20 in the same manner as that of FIG. 1, but securing to one another in the opposite direction. Thus, the latch 18 can be hinged and pivotable in 180-degrees or greater, in order to permit latching to the tab 20 in both the closed position and the fully-opened position. The latch 18 secures the tackle box assembly 10 in the fully-opened position, permitting a user to lay the tackle box assembly 10 down, and use the insert 40 for placing, removing, or otherwise working with lures, flies, or other bait.

In this way, the insert 40 can be thought of as a ‘page’, such as a page of a book, wherein the outer casing 12 forms the front and rear covers of the book, and the insert 40 forms one page. As such, it is contemplated that the insert 40 can be separated into a set of pages or multiple pages, such that the insert 40 is formed as multiple inserts for storing multiple sets of flies or lures. Additionally, it is contemplated that the pages of the inserts 40, in such an embodiment, can be shaped or otherwise arranged to contain the lures and permit flat enclosure of the insert 40 (or pages thereof) when the tackle box assembly 10 is in the closed position. More specifically, it is contemplated that the insert 40 can include recesses, channels, spaces, or otherwise, providing room for fitting one or more lures or flies among the pages of the insert 40.

It should be appreciated that in the fully-opened position, the ends of the first half 14 and the second half 16 of the outer casing 12 can act as a common handle, which provides for carrying the tackle box assembly 10 in the opened position, or for handling the tackle box assembly 10 to manipulate the insert 40, such as for removal or insertion at the spine 24, as is described in detail herein.

Referring now to FIG. 4, the tackle box assembly 10 having the insert 40 exploded from the spine 24, and better illustrating the geometry of the interior edge 48 of the insert 40 which connects to the spine 24. The interior edge 48 of the insert 40 can further include an attachment end 80, adapted to connect to the outer casing 12 at the spine 24. The attachment end 80 further includes an increased height 82 relative to the remainder of the insert 40, measured between the top edge 50 and the bottom edge 52 along the interior edge 48, as compared to that of the exterior edge 46 or the remainder of the insert 40. The height 82 of the attachment end 80 can be sized to be slightly larger than that of the spine 24, such that inserting the attachment end 80 into the spine 24 slightly compresses the insert 40 at the attachment end 80, in order to compressibly secure the insert 40 to the spine 24. Furthermore, the spine 24 can include a pair of opposing lips or flanges 84 spaced slightly smaller than that of the height 82 of the attachment end 80 in order to assist in compressibly securing the attachment end 80 to the spine 24 via the flanges 84.

The attachment end 80 can also include a slot 86, which can be sized and positioned complementary to a rib 72 provided on the spine 24, to further guide and secure the insert 40 to the spine 24 during reattachment. The rib 72 can provide for improved attachment by assisting with compression of the insert 40 against the flanges 84, as well as properly aligning the insert 40 to permit closure of the tackle box assembly 10.

Additionally, the attachment end 80 can include a pair of opposing end slots 88, provided in the attachment end 80 where the attachment end 80 meets the top and bottom edges 50, 52. The end slots 88 can be adapted to receive opposing fingers 90 extending from the top and bottom of the spine 24 at the flanges 84, extending toward one another. In this way, the insert 40 can be compressed and inserted against the spine 24. The insert 40 can be secured at the spine 24 using the rib 72 and the opposing fingers 90 to secure the insert 40 at the end slots 88 to the spine 24 upon re-expansion of the insert 40 after compression for connection to the spine 24. Similarly, compression of the insert 40 can be used to release the fingers 90 and the rib 72 from the end slots 88 and the side slot 86, respectively, in order to remove the insert 40 from the spine 24. Additionally, the spine 24 can include sidewalls 100, which can provide for additional support to secure the attachment end 80 within the spine 24, while it is contemplated that the spine 24 need not include the sidewalls 100.

Alternatively, any suitable means of connecting the insert 40 to the spine 24 is contemplated, such as utilizing fasteners such as a pin, screw, snap, adhesives, or button in non-limiting examples, while any suitable method of fastening is contemplated.

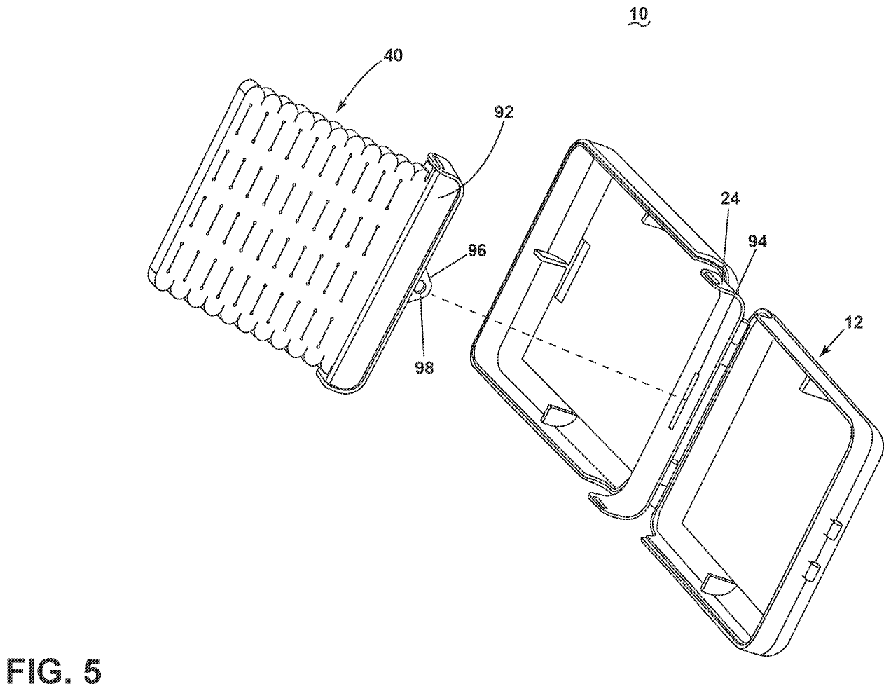

Referring now to FIG. 5, the tackle box assembly 10 is again shown in the partially-opened position, similar to that of FIG. 2, except a spine connector 92 has been exploded from the spine 24, with the spine connector 92 attached to the insert 40. The spine 24 can further include a spine slot 94 formed in the spine 24. The spine connector 92 can include a fastener extension 96, which can be sized complementary to the spine slot 94 for attachment of the spine connector 92 to the spine 24. Furthermore, the spine connector 92 can physically attach or connect to the spine 24, such as with the use of a snap-fit, or any other suitable releasable plug-in or pull-out connection assembly. Additionally, upon attachment, the fastener extension 96 can extend through the spine slot 94, to provide for fastening the tackle box assembly 10 to a connector when either the insert 40 is attached to the remainder of the outer casing 12, or not. Additionally, removal of the spine connector 92 from the spine 24 permits ease of connection of the insert to the spine 24, without requiring the user to attach the insert 40 into the spine connector 92 as already connected to the spine 24. Furthermore, it permits the user to take the insert 40 with them alone, without the rest of the outer casing 12, which is bulkier than the insert 40 itself. The opening 98 on the fastener extension 96 permits the user to attach the insert 40 to another fastener, such as the user's clothing or other hook, for carrying the insert 40 and any lures or flies attached to the insert 40. It is further contemplated that one or more grommets or seals can be placed on the spine connector 92, such that the tackle box assembly 10 can be waterproof or water resistant at the spine 24 when the spine connector 92 is attached.

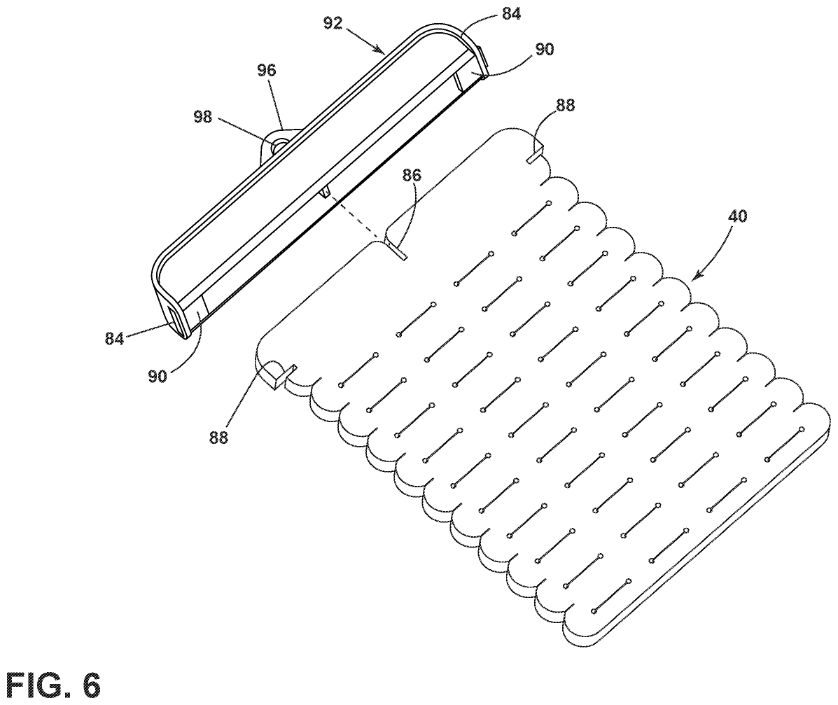

Referring now to FIG. 6, the spine connector 92 and the insert 40 are isolated, having the outer casing 12 removed from view. As is appreciable, the insert 40 is connectable to and removable from the spine connector 92, in the same manner as described in FIG. 4, with the insert 40 being compressibly connectable to the spine connector 92 at the flanges 84 and the rib 72.

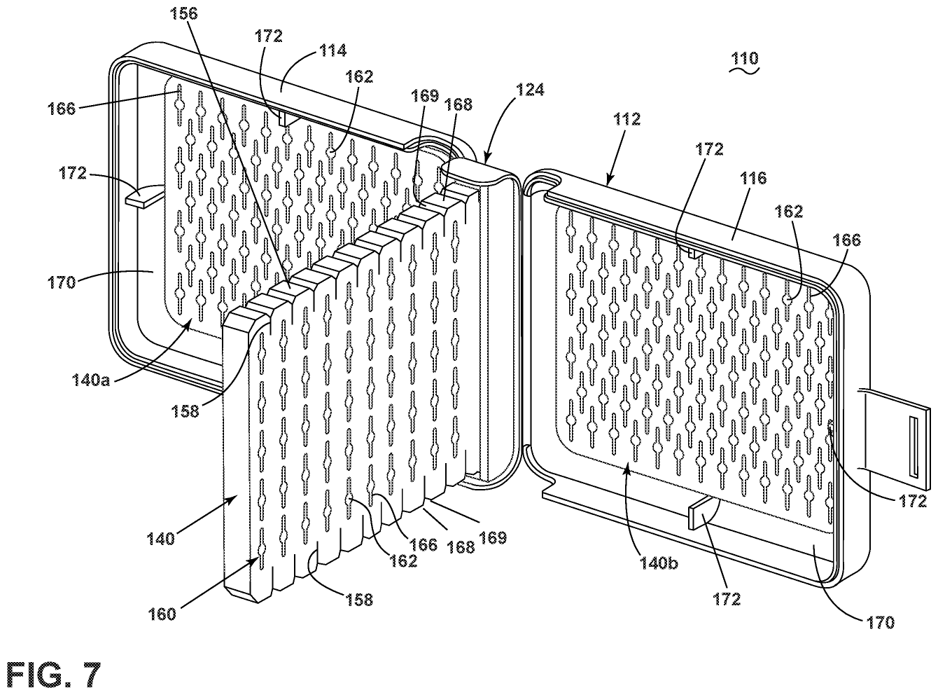

Referring now to FIG. 7, another exemplary tackle box assembly 110 is shown. The tackle box assembly 110 can be substantially similar to the tackle box assembly of FIGS. 1-6, except that additional inserts 140a, 140b are provided with the outer casing 112. Therefore, similar numerals will be used to describe similar elements, increased by a value of one hundred. The discussion will be limited to differences between the tackle box assembly 10 of FIGS. 1-6 and the tackle box assembly 110 of FIG. 7, and numerals not specifically referenced should be considered to be equivalent to those described in the prior example, decreased by a value of one hundred.

The tackle box assembly 110 includes the outer casing 112 having a first half 114 and a second half 116, each having an interior surface 170. An insert 140 is attached to a spine 124. Additional inserts 140a, 140b are provided within the first half 114 and the second half 116, attached along the interior surface 170 of the first half 114 and the second half 116. In one example, the inserts 140a, 140b can be secured to the first and second halves 114, 116, such as with an adhesive. Additionally, the ribs 172 provide for aligning the proper position for the inserts 140a, 140b, as well as partially securing the inserts 140a, 140b to the first half 14 and the second half 116.

Additionally, openings 160 are provided on the inserts 140, 140a, 140b. The openings 160 on the insert 140 attached to the spine 124 include a slit 166 extending in a vertical direction, giving reference to the position shown in the figure. Additionally, the openings 160 include a central hole 162, positioned in the middle of the slit 166, relative to the vertical direction as shown. Additionally, the openings 160 on the insert 140 are arranged in aligned rows and columns, while any suitable arrangement is contemplated, and that as shown is by way of example only. Additionally, it is contemplated that the slit 166 and related hole 162 can vary, such as changing the position, direction, or alignment of the slit 166, or changing the placement of the hole 162 along the slit 166. Furthermore, while the slits 166 are depicted as wider or larger than the slits shown in FIGS. 2-6, it should be understood that any suitable sizing, width, height, depth, cross-sectional area or shape can be contemplated, and may or may not include one or more holes 162. In one example, the slits 166 could be replaced with the slits 66 of FIGS. 2-6. Further still, the slits 166 need not be slits at all, but can be any suitable feature, formed into or extending out of the inserts for providing for supporting lures or other tackle.

Referring to the additional inserts 140a, 140b, each insert also includes similar openings 160 to that of the middle insert 140, while any suitable opening 160 is contemplated. Additionally, the openings 160 on the additional inserts 140a, 140b are more tightly grouped, as compared to the middle insert 140, and are arranged in an offset manner, with offset rows and columns of openings 160. Additionally, it should be appreciated that a thickness for one or more of the inserts 140, 140a, 140b, can be somewhat reduced, compared to the other inserts or the size of the casing 112, to permit closing of the outer casing 112 while additional lures or bait are attached to the inserts 140, 140a, 140b.

Finally, it should be understood that the bumps 156 include angled edges 169 extending between a groove 158 and a top surface 168. As such, any suitable geometry for the bumps 156 or the insert 140 is contemplated.

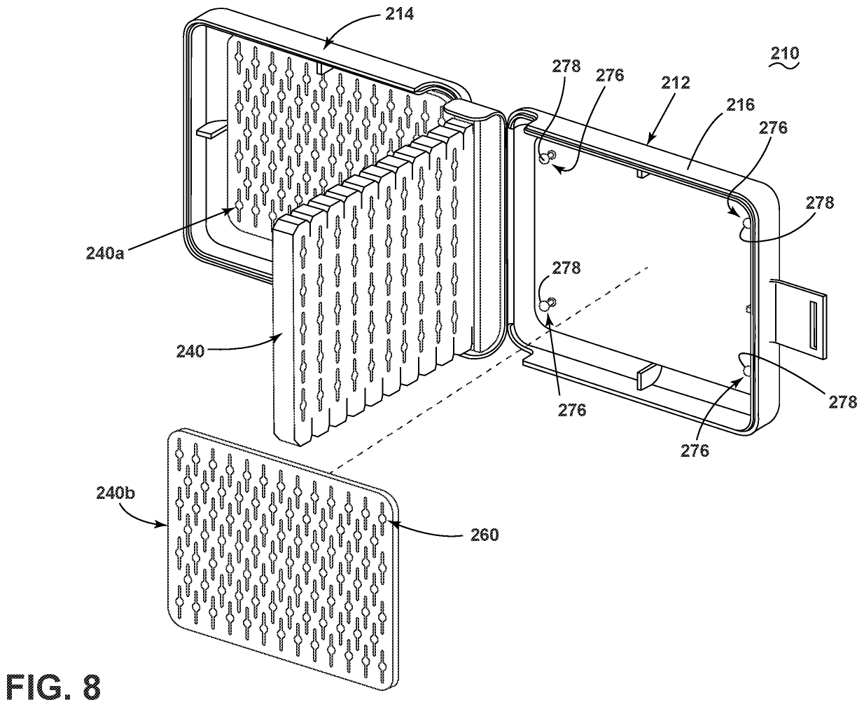

Referring now to FIG. 8, another exemplary tackle box assembly 210 is shown. The tackle box assembly 210 can be substantially similar to the tackle box assembly of FIG. 7, except that additional inserts 240a, 240b are provided with the outer casing 212 in addition to the central insert 240 attached to the spine, and the additional inserts 240a, 240b are removably attached to the first half 214 and the second half 216 by one or more pegs 276. As such, similar numerals will be used to describe similar elements, increased by a value of one hundred and the discussion will be limited to differences between the two.

As can be appreciated, one additional insert 240b is exploded from the outer casing 212. The insert 240b, as well as the other insert 240a, can be removable attached to the outer casing 212 via the pegs 276. The pegs 276 can include a bulbous end 278, which can be insertable through the openings 260 in the inserts 240a, 240b to secure the inserts 240a, 240b to the outer casing 212 with an interference fit, as the inserts 240a, 240b are compressible. While four pegs 276 are shown on each half 214, 216 of the outer casing 212, any suitable number or position of the pegs 276 is contemplated. It is desirable, however, that the pegs 276 are arranged complementary to the intended inserts 240a, 240b to provide for attachment to the tackle box assembly 210. Other alternative fasteners are contemplated, such as clips, spring fingers, or tabs in non-limiting examples.

To the extent not already described, the different features and structures of the various aspects can be used in combination, or in substitution with each other as desired. That one feature is not illustrated in all of the examples is not meant to be construed that it cannot be so illustrated, but is done for brevity of description. Thus, the various features of the different aspects can be mixed and matched as desired to form new aspects, whether or not the new aspects are expressly described. All combinations or permutations of features described herein are covered by this disclosure.

This written description uses examples to describe aspects of the disclosure provided herein, including the best mode, and also to enable any person skilled in the art to practice aspects of the disclosure, including making and using any devices or systems and performing any incorporated methods. The patentable scope of aspects of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A tacklebox for storing and preparing lures, the tacklebox comprising:
a casing defining an interior, the casing including a first casing half and a second casing half joined to the first casing half at a spine, the casing moveable between a closed position and an opened position;
an insert removably attached to the casing at the spine and enclosed within the interior when the casing is in the closed position; and
at least one finger provided on the spine configured to removably secure the insert to the casing at the spine.

2. The tacklebox of claim 1 further comprising at least one end slot complementary, with the at least one end slot receiving the at least one finger when the insert is attached to the spine.

3. The tacklebox of claim 1 further comprising at least one rib provided on the spine to align the insert alone the spine.

4. The tacklebox of claim 3 wherein the insert further includes a slot configured to align at the at least one rib.

5. The tacklebox of claim 1 wherein the insert includes an interior edge that fastens to the spine to attach the insert to the casing.

6. The tacklebox of claim 1 wherein the spine includes a spine slot.

7. The tacklebox of claim 6 wherein the insert includes a fastener extension that extends through the spine slot when the insert attaches to the spine.

8. The tacklebox of claim 1 wherein the insert includes a set of openings.

9. The tacklebox of claim 8 wherein each opening of the set of openings includes a hole arranged centrally along each opening.

10. The tacklebox of claim 1 further comprising a latch for securing the casing in either the opened position or the closed position.

11. The tacklebox of claim 10 wherein the first casing half connects to the spine at a first hinge and the second casing half connects to the spine at a second hinge to permit 180-degree movement between the first casing half and the spine, and the second casing half and the spine.

12. The tacklebox of claim 11 wherein the insert is arranged as a set of pages.

13. A tacklebox assembly comprising:
a casing including a first half connected to a second half by a spine, and the casing movable between an opened position and a closed position; and
an insert removably attached to the casing at the spine and configured to carry fishing lures.

14. The tacklebox assembly of claim 13 further comprising two additional inserts.

15. The tacklebox assembly of claim 14 wherein one of the two additional inserts attaches to the first half of the casing, and the other of the two additional inserts attaches to the second half of the casing.

16. The tacklebox assembly of claim 15 wherein the two additional inserts are identical, but are different from the insert attached to the spine.

17. A method of storing lures in a tackle box assembly, the method comprising;
attaching at least one lure to an insert carried within a casing;
removably securing the insert to a spine of the casing by positioning at least one finger on the spine into at least one complementary slot on the insert; and
closing the casing by attaching a first half to a second half, encasing the insert.

18. The method of claim 17 further comprising securing the at least one lure to the insert at an opening in the insert.

19. The method of claim 17 further comprising preparing the at least one lure on the insert.

20. The method of claim 17 wherein attaching the at least one lure to the insert further comprises attaching at least one lure to a page of the insert.
